(19) United States
(12) Patent Application Publication
(10) Pub. No.: US 2021/0373866 A1
(43) Pub. Date: Dec. 2, 2021

(54) BOTTLENECK DETECTION DEVICE AND COMPUTER READABLE MEDIUM

(71) Applicant: Mitsubishi Electric Corporation, Tokyo (JP)

(72) Inventors: Masayuki KIRIMURA, Tokyo (JP); Hirotaka MOTAI, Tokyo (JP); Kiyotaka MORITA, Tokyo (JP)

(73) Assignee: Mitsubishi Electric Corporation, Tokyo (JP)

(21) Appl. No.: 17/399,157

(22) Filed: Aug. 11, 2021

Related U.S. Application Data
(63) Continuation of application No. PCT/JP2019/008667, filed on Mar. 5, 2019.

(51) Int. Cl. G06F 8/41

(52) U.S. Cl. CPC G06F 8/4441; G06F 8/4452

(57) ABSTRACT

A target apparatus (20) includes a bottleneck term calculation unit (22) and a running function recording scheduler (24). The bottleneck term calculation unit (22) acquires a performance graph, which is generated about run of a single program being a running subject or about run of a plurality of programs being a running subject and which indicates correspondence between a lapse of time and a load quantity being set as a load. The bottleneck term calculation unit (22) calculates, using a performance graph, a bottleneck term indicating a term where the load quantity in a limit status continues. The running function recording scheduler (24) records, during next run of the single program or of the plurality of programs to be run after the run, being an origin of generation of the performance graph, of the single program or the plurality of programs, a function which is run during the bottleneck term, using a running function recording module (23).

### CROSS REFERENCE TO RELATED APPLICATIONS

This application is a Continuation of PCT International Application No. PCT/JP2019/008667 filed on Mar. 5, 2019, which is hereby expressly incorporated by reference into the present application.

### TECHNICAL FIELD

The present invention relates to a bottleneck detection device and a bottleneck detection program which detect a performance bottleneck occurring when a program runs.

### BACKGROUND ART

According to Patent Literature 1, a single method being a cause of a bottleneck is identified with a first-time program run, and the method is revised, or is rebuilt with a trace option. With a second-time program run, a trace result of the identified method is recorded. Patent Literature 1 discloses a method that automatizes this series of processes.

In the case of Patent Literature 1, it is necessary to revise or rebuild the program concerning the identified method, or to set parameters of an application. Therefore, even if the series of processes are automatized, processing from finding the performance bottleneck in the program till identifying the cause of the performance bottleneck takes time. Also, in the case of Patent Literature 1, it is difficult to identify a bottleneck of processing related to a plurality of methods.

### CITATION LIST

### Patent Literature

Patent Literature 1: JP 2003-140928 A

### SUMMARY OF INVENTION

### Technical Problem

It is an objective of the present invention to provide a bottleneck detection device that can quickly handle processing from finding a performance bottleneck in a program till identifying a cause of the performance bottleneck.

### Solution to Problem

A bottleneck detection device according to the present invention includes:

a term calculation unit to acquire load information which is generated about at least one run of a running subject being either one or the other of a single program and a plurality of programs and which indicates correspondence between a lapse of time and a load quantity being set as a load, and to calculate, using the load information, a bottleneck term indicating a term where the load quantity in a limit status continues; and

a recording scheduler to record, during run of the running subject which is run after the run being an origin of generation of the load information, a function which is run during the bottleneck term, using a tracing feature.

### Advantageous Effects of Invention

According to the present invention, a bottleneck detection device can be provided that can quickly handle processing of finding a performance bottleneck in a program till identifying a cause of the performance bottleneck.

### BRIEF DESCRIPTION OF DRAWINGS

FIG. 1 is a drawing of Embodiment 1 presenting a configuration diagram of a bottleneck detection system 1001.

FIG. 2 is a drawing of Embodiment 1 schematically illustrating a bottleneck term Tb.

FIG. 3 is diagram of Embodiment 1 presenting a flowchart illustrating an outline of operations of a target apparatus 20.

FIG. 4 is a drawing of Embodiment 1 presenting another flowchart illustrating the operations of the target apparatus 20.

FIG. 5 is a drawing of Embodiment 1 illustrating performance data 311 and a performance graph.

FIG. 6 is a drawing of Embodiment 1 illustrating the bottleneck term Tb.

FIG. 7 is a drawing of Embodiment 1 illustrating a method of calculating the bottleneck term Tb by a bottleneck term calculation unit 22.

FIG. 8 is a drawing of Embodiment 1 illustrating running function trace data 331.

FIG. 9 is a drawing of Embodiment 1 illustrating a course that lasts till the running function trace data 331 is generated.

FIG. 10 is a drawing of Embodiment 2 presenting a configuration diagram of a bottleneck detection system 1002 of Embodiment 2.

FIG. 11 is a drawing of Embodiment 3 presenting a configuration diagram of a bottleneck detection system 1003 of Embodiment 3.

FIG. 12 is diagram of Embodiment 3 presenting a flowchart illustrating an outline of operations of a target apparatus 20 of Embodiment 3.

FIG. 13 is diagram of Embodiment 3 presenting a flowchart illustrating the operations of the target apparatus 20 in detail.

FIG. 14 is diagram of Embodiment 4 presenting a flowchart illustrating an operation outline of a target apparatus 20.

FIG. 15 is a diagram of Embodiment 4 explaining a logical-sum method.

FIG. 16 is a diagram of Embodiment 5 illustrating a hardware configuration of a bottleneck detection device 100.

FIG. 17 is a diagram of Embodiment 5 illustrating another hardware configuration of the bottleneck detection device 100.

FIG. 18 is a diagram of Embodiment 5 illustrating how features of the bottleneck detection device 100 are implemented by hardware.

### DESCRIPTION OF EMBODIMENTS

Embodiments of the present invention will be described with referring to drawings. In the drawings, the same or equivalent portions are denoted by the same reference sign. In description of the embodiments, the same or equivalent portions will not be described, or will be described simply.

### Embodiment 1

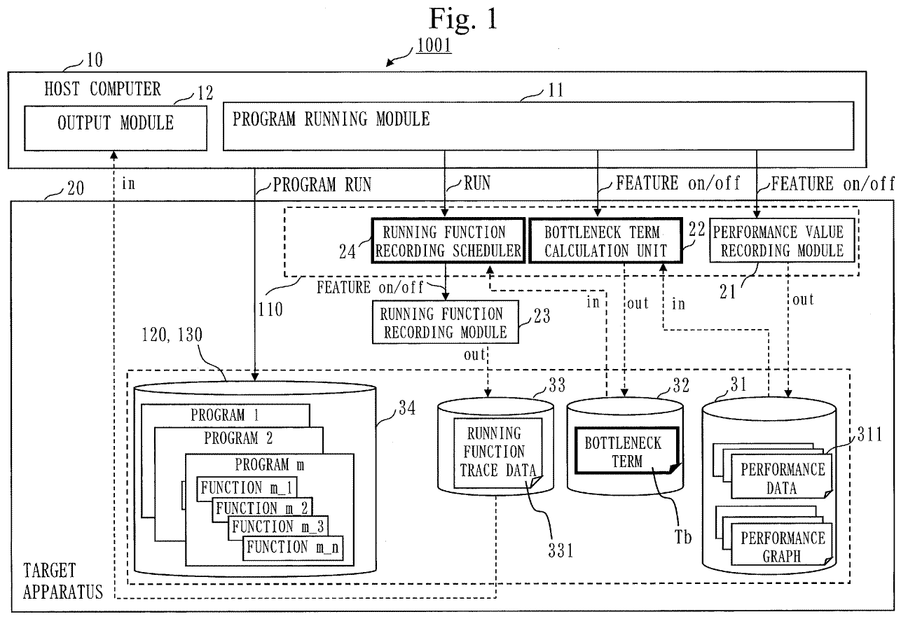

A bottleneck detection system 1001 according to Embodiment 1 will be described with referring to FIGS. 1 to 9.

FIG. 1 illustrates a configuration of the bottleneck detection system 1001. The bottleneck detection system 1001 is provided with a host computer 10 and a target apparatus 20. The bottleneck detection system 1001 detects a performance bottleneck of the computer. More specifically, the bottleneck detection system 1001 detects a function that causes a performance bottleneck, without rebuild or revision.

The performance bottleneck refers to a situation where a processor load or a system load such as an I/O throughput that is close to a performance limit of the computer continues for a predetermined period of time. The performance bottleneck will be expressed as a bottleneck hereinafter. In the following, a Central Processing Unit (CPU) load is raised as an example of the processor load. The host computer 10 tests the target apparatus 20.

The host computer 10 detects bottlenecks of programs 1, 2, 3, . . . , m of the target apparatus 20 by automatically running the programs 1, 2, 3, . . . , m. FIG. 1 illustrates the programs 1, 2, 3, . . . , m. Although not illustrated, the program 1 has functions 11, 12, . . . , 1. Although not illustrated, the program 2 has functions 21, 22, . . . , 2n. Although not illustrated, the program m has functions m1, m2, . . . , mn.

A term “running subject” is used in the following description. A “running subject” is either one or the other of a single program and a plurality of programs. When the running subject is a single program, for example, the program 1 of FIG. 1 is the running subject. When the running subject is a plurality of programs, for example, the programs 1 to m of FIG. 1 are the running subject.

The running subject is run a plurality of times. If the running subject is a single program, the same single program is run a plurality of times. If the program 1 of FIG. 1 is the running subject as a single program, the program 1 is run a plurality of times. When running the single program 1 a plurality of times, a running order of functions which are run the first time is maintained in the second and subsequent runs.

If the running subject is a plurality of programs, the same set of the plurality of programs is run a plurality of times. If m pieces of programs that are the program 1 to the program m of FIG. 1 are the running subject as a plurality of programs, the programs 1 to m are run a plurality of times. First run, second run, and so on of the programs 1, 2, 3, . . . , m are specifically as follows. In first run, second run, and so on, a running order of the plurality of programs 1, 2, 3, . . . , m which are run the first time, and a running order of functions constituting each program are maintained in the second and subsequent runs.

***Description of Configurations***

The host computer 10 is provided with a program running module 11 and an output module 12.

(1) The program running module 11, by following a rule being set in advance, takes the target apparatus 20 as a target, and automatically runs a running subject which is either one or the other of a single program and a plurality of program.

The program running module 11 is handled by a Continuous Integration (CI) tool. In the target apparatus 20, a processor of the target apparatus 20 runs the running subject. The program running module 11 turns on/off a feature of a performance value recording module 21 and a feature of a bottleneck term calculation unit 22. The program running module 11 runs a running function recording scheduler 24. The program running module 11 runs the running subject.

The running function recording scheduler 24 is a recording scheduler.

(2) The output module 12 outputs a trace result of a function that causes a bottleneck of the running subject.

The target apparatus 20 is provided with the performance value recording module 21, the bottleneck term calculation unit 22, a running function recording module 23, the running function recording scheduler 24, a first storage unit 31, a second storage unit 32, a third storage unit 33, and a fourth storage unit 34.

(1) The performance value recording module 21 records a status of a performance load of the entire apparatus such as a CPU usage and an I/O Wait, as performance data 311 in a time series. The performance data 311 is, for example, a performance log of the CPU usage. The performance value recording module 21 generates a performance graph from the performance data 311. As illustrated in FIG. 1, the performance value recording module 21 stores the performance graph in the first storage unit 31 together with the performance data 311. (2) The bottleneck term calculation unit 22 identifies a portion where the bottleneck occurs from the performance graph generated on the basis of the performance data recorded by the performance value recording module 21, and calculates a bottleneck term Tb from a bottleneck start time point Ts to a bottleneck end time point Te.

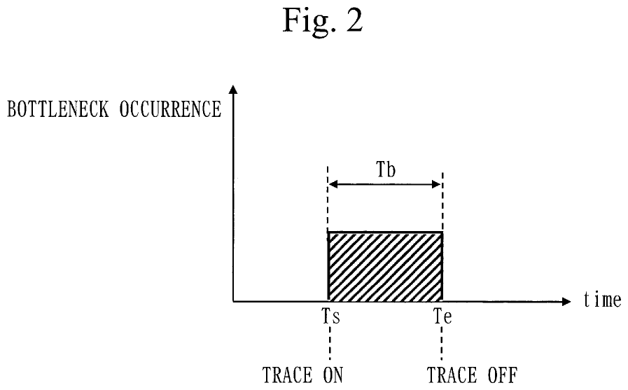

FIG. 2 schematically illustrates the bottleneck term Tb. In FIG. 2, a duration from the start time point Ts to the bottleneck end time point Te is the bottleneck term Tb. How to calculate the bottleneck term Tb will be described later.

(3) When the feature of the running function recording module 23 has been turned on by the running function recording scheduler 24 which is the recording scheduler, the running function recording module 23 records functions that have been run, in a time series.

(4) The running function recording scheduler 24 turns on the feature of the running function recording module 23 to cause the running function recording module 23 to record functions to run during the bottleneck term Tb, in a time series.

The running function recording scheduler 24 is a scheduler that controls a recording timing of a function to run.

(5) The first storage unit 31 stores a plurality of pieces of performance data 311 outputted by the performance value recording module 21.

(6) The second storage unit 32 stores the bottleneck term Tb outputted by the bottleneck term calculation unit 22.

(7) The third storage unit 33 stores running function trace data 331 recorded by the running function recording module 23.

(8) The fourth storage unit 34 stores a plurality of program to be run by the program running module 11. FIG. 1 illustrates that the program m has functions m1, m2, . . . , mn. When the function m1 and m2 are run in the bottleneck term Tb, run of the functions m1 and m2 is recorded, together with time points, by the running function recording module 23.

***Description of Operations***

<Outline of Operations of Target Apparatus 20>

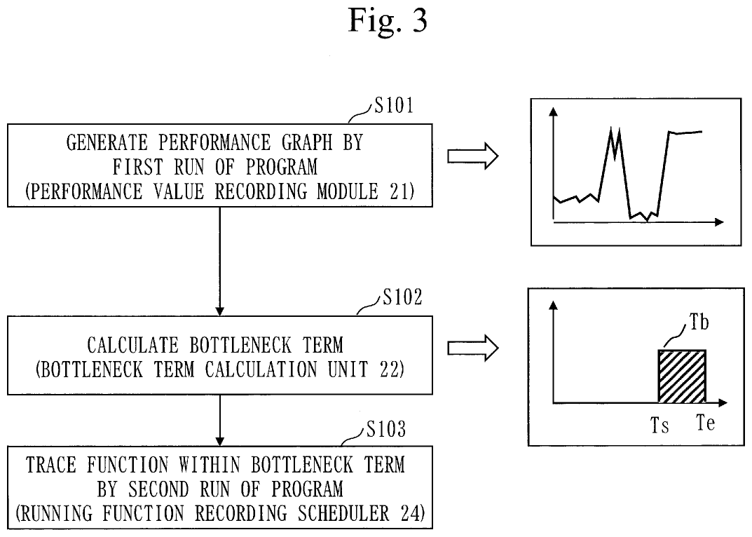

FIG. 3 is a flowchart illustrating an outline of operations of the target apparatus 20 of Embodiment 1. In FIG. 3, parenthesized indicates a subject of the operations. The operations of the target apparatus 20 correspond to a function recording method. The operations of the target apparatus 20 also correspond to processing of a bottleneck detection program.

In Embodiment 1, the bottleneck term calculation unit 22 acquires load information which is generated about at least one run of a running subject being either one or the other of a single program and a plurality of programs and which indicates correspondence between a lapse of time and a load quantity being set as a load. The load information is a performance graph. The performance graph is also load information. The bottleneck term calculation unit 22 calculates, using the load information, a bottleneck term indicating a term where a load quantity in a limit status continues.

In an environment where continuous integration and batch script can be run repeatedly, the target apparatus 20 executes steps S101 to S103 automatically.

In step S101, the performance value recording module 21 generates a performance graph which is a load graph of a CPU usage, a memory use quantity, an I/O throughput performance, or the like by first run of the running subject.

In step S102, the bottleneck term calculation unit 22 calculates the bottleneck term Tb in the performance graph.

In step S103, the running function recording scheduler 24 turns on a tracing feature of the running function recording module 23 by second run of the running subject, within the bottleneck term Tb obtained by step S102, and records a trace log using the running function recording module 23. When the bottleneck term Tb ends, the running function recording scheduler 24 turns off the tracing feature of the running function recording module 23. Hence, the running function recording scheduler 24 does not execute recording of the trace log using the running function recording module 23 except during the bottleneck term Tb. Using the running function recording module 23, the running function recording scheduler 24 extracts, from the trace log, the function which is run during the bottleneck term Tb, and generates the running function trace data 331.

In Embodiment 1, the load information is generated about one run of the running subject which is either one or the other of a single program and a plurality of programs. The bottleneck term calculation unit 22 calculates the bottleneck term from this load information.

Following are features of steps S101 to S103 described above.

(1) A recording volume of the trace log is reduced by switching on/off of the running function recording module 23 being a tracing feature, instead of setting a tracing feature in a running subject to be traced.

(2) In first run, the target apparatus 20 decides the bottleneck term Tb as a trace log recording term.

(3) In second run, when the bottleneck term Tb is reached, the target apparatus 20 turns on the running function recording module 23 being a tracing feature and records the trace log. When the bottleneck term Tb elapses, the running function recording scheduler 24 turns off the running function recording module 23.

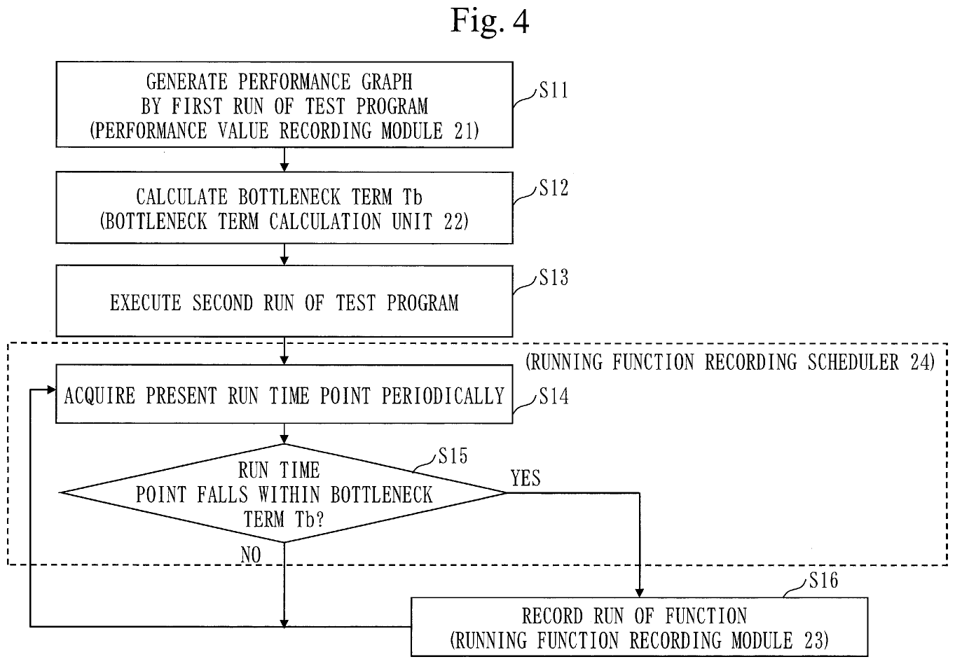

FIG. 4 is a flowchart illustrating the operations of the target apparatus 20 being a bottleneck detection device 100. The operations of the target apparatus 20 will be described with referring to FIG. 4.

<Step S11>

In step S11, by first run of the running subject, the performance value recording module 21 acquires performance data and graphs the performance data 311 into a performance graph.

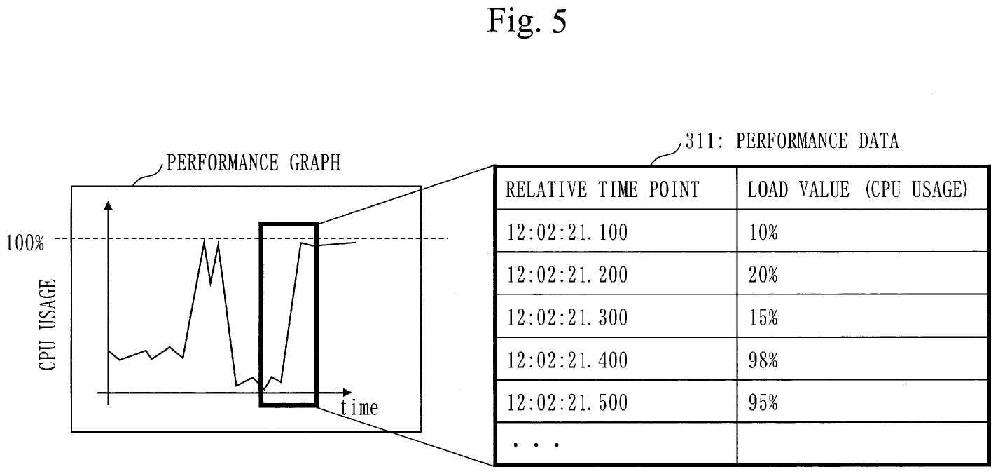

FIG. 5 illustrates the performance data 311 and the performance graph. A range of a frame of the performance graph on the left side corresponds to the performance data on the right side. The performance data 311 is data in which the load information indicating a load value such as a CPU load and an I/O throughput is recorded in a time series. The load value has a range of 0% to 100%. In principle, the load value expresses a value of the entire system. A time point is expressed as an elapsed time point from start, or from run of a particular application. In order to differentiate from an absolute time point (actual clock time point), an elapsed time point is called a “relative time point”. The performance data 311 on the right side of FIG. 5 is raw data of a text. In FIG. 5, for example, a CPU load factor is illustrated as 10% at relative time point 12:02:21.100. In the performance graph, an axis of abscissa represents a relative time point, and an axis of ordinate represents a load value. FIG. 1 illustrates the first storage unit 31 as storing the performance data 311. The first storage unit 31 also stores the performance graph.

<Step S12>

In step S12, the bottleneck term calculation unit 22 calculates the bottleneck term Tb from the performance graph. The performance graph merely expresses the performance data in a graph format. The performance graph is the performance data.

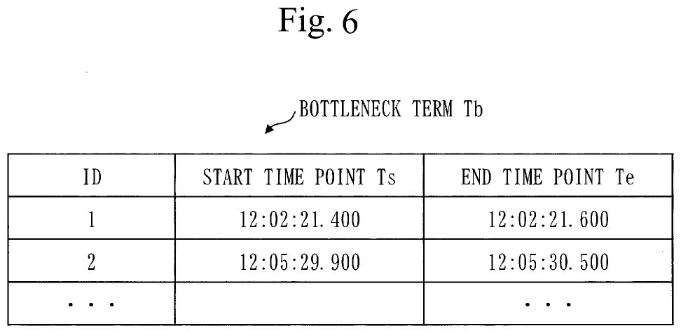

FIG. 6 illustrates the bottleneck term Tb. The bottleneck term Tb is expressed by the start time point Ts at which a bottleneck occurs, and by the end time point Te. The bottleneck term calculation unit 22 can also calculate a plurality of bottleneck terms Tb. FIG. 6 illustrates a plurality of bottleneck terms Tb. The bottleneck terms Tb are identified from each other by identification (ID). Note that ID is an option. ID=1 expresses a first bottleneck term Tb. ID=2 expresses a second bottleneck term Tb.

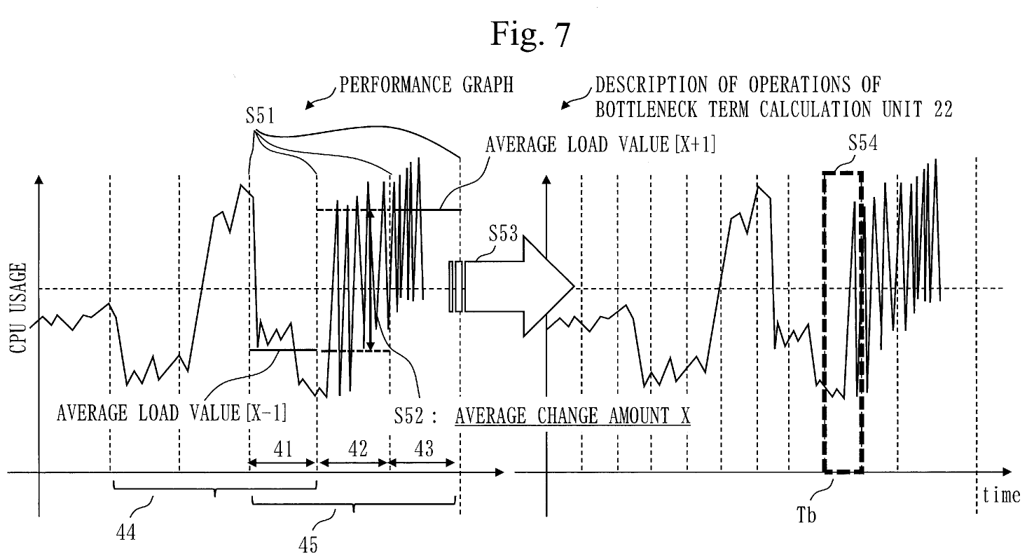

FIG. 7 illustrates a calculation method of calculating the bottleneck term Tb by the bottleneck term calculation unit 22. The calculation method of the bottleneck term Tb will be described below. The bottleneck term calculation unit 22 divides the performance graph generated from the performance data 311, being the load information, into a plurality of, three or more consecutive time zones. The bottleneck term calculation unit 22 calculates the bottleneck term Tb on the basis of a load average value of a first time zone and a load average value of a second time zone, the first time zone and the second time zone being two time zones on two sides of a central time zone of the three time-consecutive time zones.

This is specifically as follows.

In FIG. 7, the bottleneck term calculation unit 22 performs the following processing. In FIG. 7, as the performance graph, a graph of the CPU usage is used.

<Step S51>

In step S51 illustrated in FIG. 7, the bottleneck term calculation unit 22 roughly divides a time zone of the performance graph of the target apparatus 20, and calculates average load values of two time zones on two sides of the central time zone of three consecutive time zones. In FIG. 7, the bottleneck term calculation unit 22 calculates an average load value [X−1] of a range 41 and an average load value [X+1] of a range 43. Then, the bottleneck term calculation unit 22 calculates an absolute value of a difference between the average load value [X+1] and the average load value [X−1] as an average load value change amount X, as in Expression 1.

Average load value change amount X=|[X+1]−[X−1]| (Expression 1)

<Step S52>

In step S52, the bottleneck term calculation unit 22 extracts a maximum average load value change amount X among a plurality of average load value change amounts X from Expression 2.

Max [Average load value change amount X: |average load value [X+1]−average load value [X−1]|] (Expression 2)

Expression 2 indicates the maximum average load value change amount X among the plurality of average load value change amounts X. An expression on the right side of the average change amount X indicates that the average load value change amount X is calculated by Expression 1.

<Step S53>

In step S53, the bottleneck term calculation unit 22 further divides the time range into finer time zones, and calculates Expression 1 of step S51 and Expression 2 of step S52.

The above processing is executed recursively to finally identify the bottleneck term Tb (step S54).

A range 44 expresses a temporary load spike that should be removed from the bottleneck term Tb. A range 42 is where the load increases and stays high. In the range 42, it is likely that a bottleneck occurs. It is preferable that the range 42 is divided more finely and calculated as a bottleneck term.

With the above steps S51 to S54, the range 44 can be removed from the bottleneck term Tb, and a range 45 can be calculated as the bottleneck term Tb.

In step S13, the target apparatus 20 executes second run of a running subject in response to an instruction from the program running module 11.

In step S14, the running function recording scheduler 24 being the recording scheduler records, during run of a running subject which is run after the run being an origin of generation of the load information, a function which is run during the bottleneck term Tb, using a tracing feature. The running function recording module 23 is a tracing feature.

This is specifically as follows. The running function recording scheduler 24 acquires a present run time point periodically.

In step S15, the running function recording scheduler 24 judges whether the present run time point falls within the bottleneck term Tb. That is, the running function recording scheduler 24 judges whether the start time point Ts of the bottleneck term Tb is reached.

If the start time point Ts is reached (YES in step S15), the running function recording scheduler 24 turns on the feature of the running function recording module 23. The running function recording module 23 records run of the function as the running function trace data 331 (step S16).

In step S15, the running function recording scheduler 24 also judges whether the end time point Te of the bottleneck term Tb is reached. If the end time point Te is reached (NO in step S15), the running function recording scheduler 24 turns off the feature of the running function recording module 23.

Hence, the running function recording module 23 continues recording of run of the function until the end time point Te at which the bottleneck term Tb ends. The running function recording module 23 stops simultaneously when the bottleneck term Tb ends.

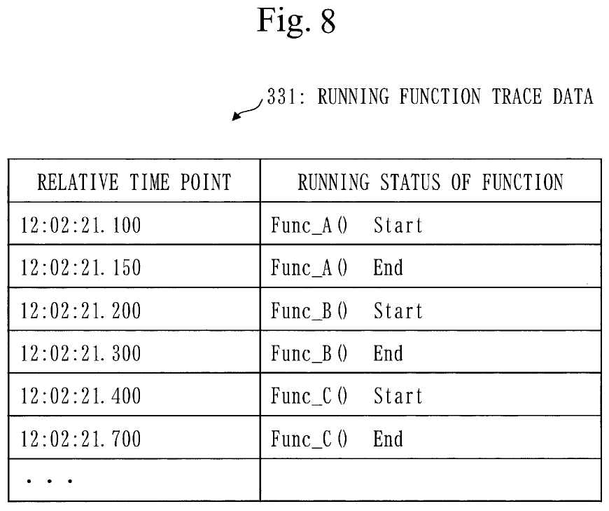

FIG. 8 illustrates the running function trace data 331. The running function trace data 331 is data that records a set of a run start time point of a function and a running status of the function, the function constituting an application and a system. For example, at relative time point 12:02:21.100, a running status of a function FuncA( ) is Start. At relative time point 12:02:21.150, the running status of the function FuncA( ) is End. If the running function recording module 23 is turned on by the running function recording scheduler 24, the running function recording module 23 records run of the function. In OFF status, the running function recording module 23 does not record run of the function. The user can see the running function trace data 331 via the output module 12 of the host computer 10. It is characteristic that the running function recording scheduler 24 turns on/off the running function recording module 23 to match the bottleneck term Tb, so as to start/stop recording of the running function.

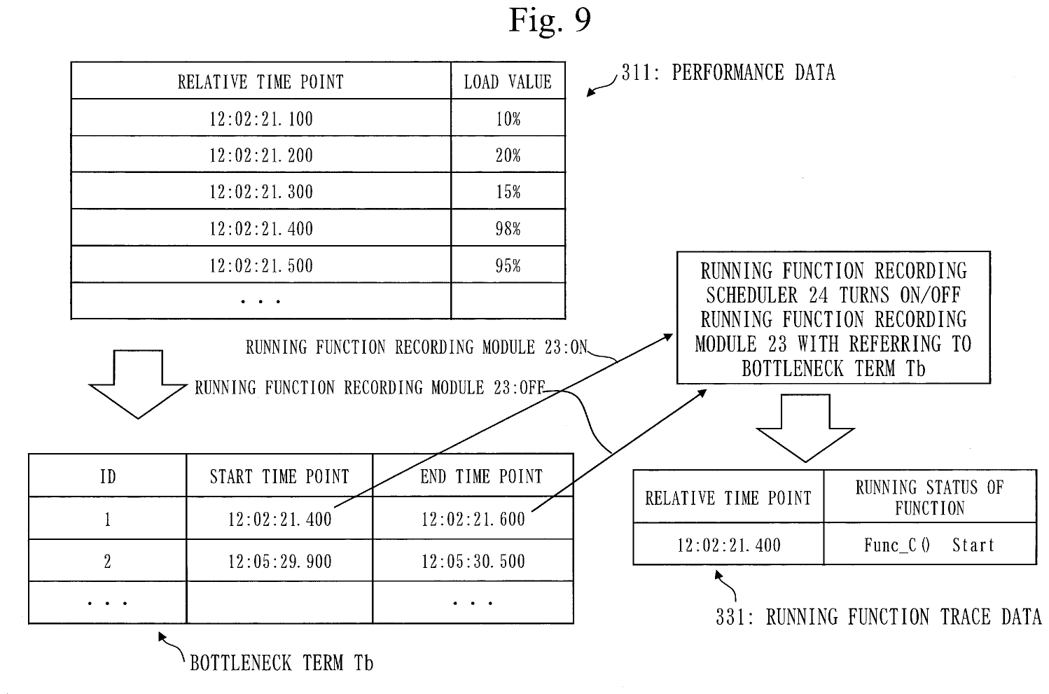

FIG. 9 illustrates a course that lasts till the running function trace data 331 is generated.

(1) First, the performance data 311 is generated by the performance value recording module 21.

(2) Then, the bottleneck term Tb is generated by the bottleneck term calculation unit 22.

(3) When the start time point Ts of the bottleneck term Tb is reached, the running function recording scheduler 24 turns on the feature of the running function recording module 23 from the OFF status. When the end time point Te of the bottleneck term Tb is reached, the running function recording scheduler 24 turns off the feature of the running function recording module 23. Except for the bottleneck term Tb, the running function recording module 23 is OFF. The running function recording module 23 records the running status of the function in the bottleneck term Tb as the running function trace data 331.

### ***Effect of Embodiment 1***

With the target apparatus 20 of Embodiment 1, the running subject need not be revised or rebuilt. Therefore, a recording time of trace log recording (step S16), which is performed by the running function recording scheduler 24 with using the running function recording module 23, can be shortened.

Also, since the running subject of the target apparatus 20 need not be rewritten, less influence is exerted on the run time of the running subject of the target apparatus 20 than in a conventional case. This is effective for a built-in apparatus that requires time for rebuild.

Since the running function recording module 23 generates a trace log only during the bottleneck term Tb, the log recording volume can be made smaller than in the conventional case.

### Embodiment 2

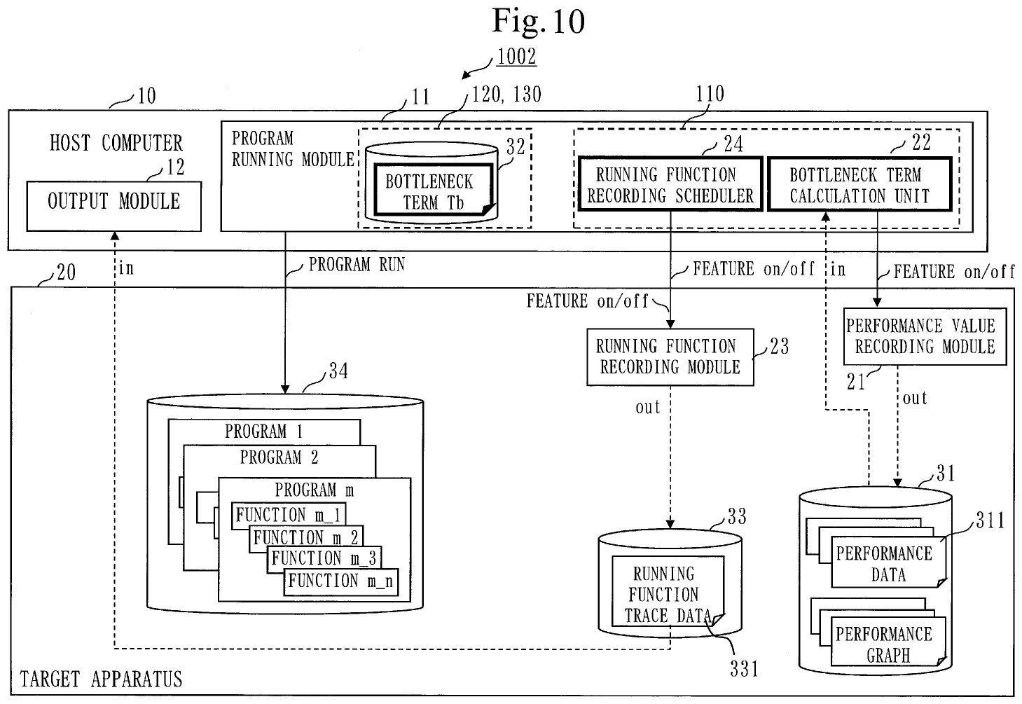

FIG. 10 is a configuration diagram of a bottleneck detection system 1002 of Embodiment 2. The bottleneck detection system 1002 of Embodiment 2 will be described with referring to FIG. 10. The bottleneck detection system 1002 is the same as the bottleneck detection system 1001 of Embodiment 1 in the respect that the bottleneck detection system 1002 records a trace log of a running function within a bottleneck term Tb. The bottleneck detection system 1002 is different from the bottleneck detection system 1001 in the respect that a bottleneck term calculation unit 22, a running function recording scheduler 24, and a second storage unit 32 which stores a bottleneck term are arranged in a host computer 10. In the bottleneck detection system 1002, the host computer 10 is a bottleneck detection device 100.

### ***Effect of Embodiment 2***

Since the bottleneck term calculation unit 22 and the running function recording scheduler 24 are arranged in the host computer 10, a function that causes a bottleneck can be identified without changing a software configuration of the target apparatus 20.

### Embodiment 3

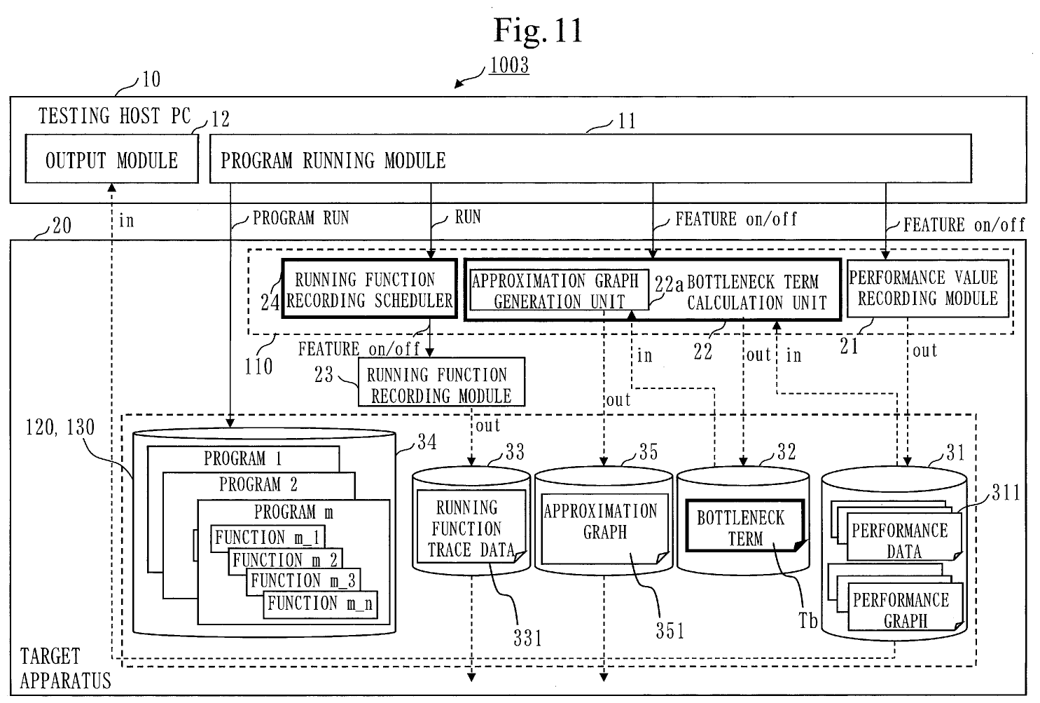

A bottleneck detection system 1003 of Embodiment 3 will be described with referring to FIGS. 11, 12, and 13.

FIG. 11 is a configuration diagram of the bottleneck detection system 1003 of Embodiment 3.

In the bottleneck detection system 1003, a bottleneck term calculation unit 22 of a target apparatus 20 has an approximation graph generation unit 22a.

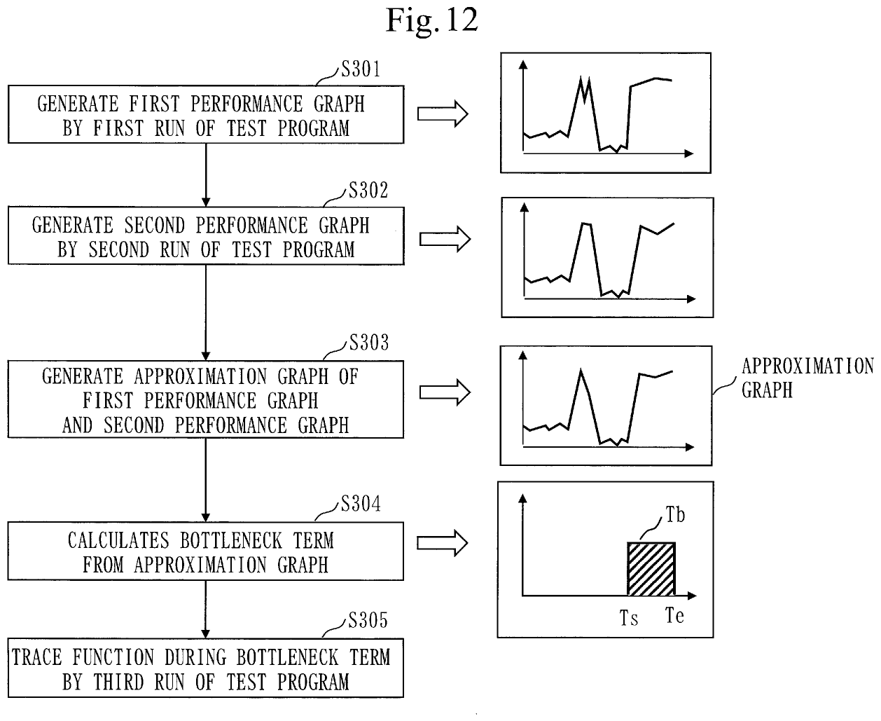

FIG. 12 is a flowchart illustrating an outline of operations of the target apparatus 20 of Embodiment 3.

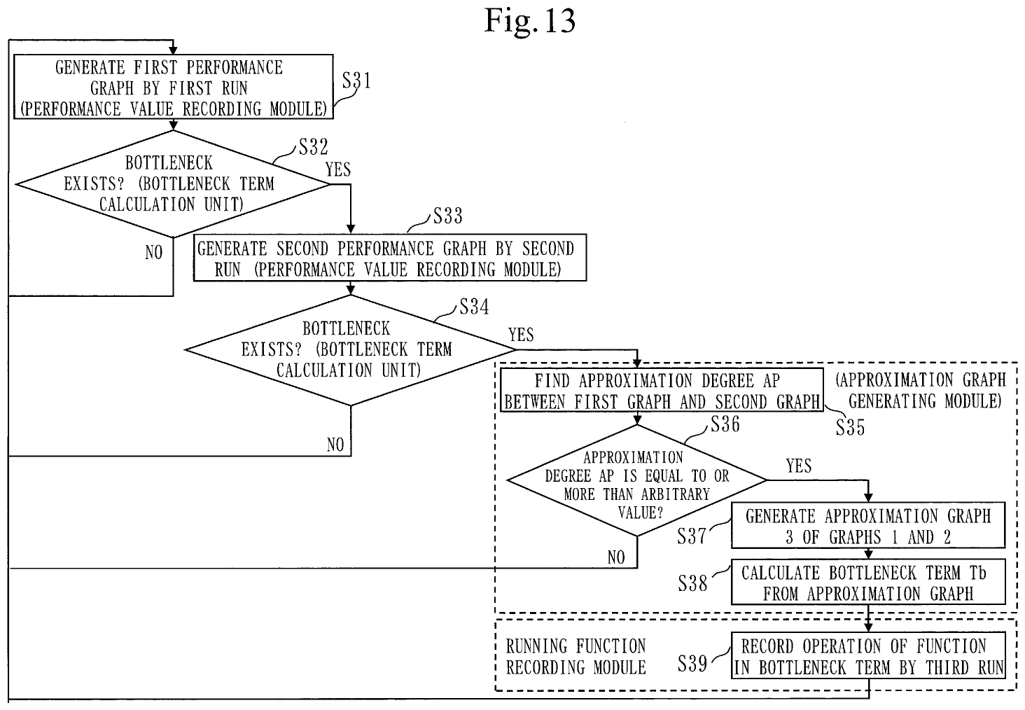

FIG. 13 is a flowchart illustrating the operations of the target apparatus 20 in detail. In the bottleneck detection system 1003, the target apparatus 20 is a bottleneck detection device 100 of Embodiment 3.

The operation outline of the target apparatus 20 will be described with referring to FIG. 12. In Embodiment 3, the bottleneck term calculation unit 22 acquires a plurality of pieces of load information generated per plurality of times of runs of a running subject which is either one or the other of a single program and a plurality of programs. The bottleneck term calculation unit 22 generates, from the plurality of pieces of acquired load information, approximation information which is approximate to each of the plurality of pieces of load information, and calculates a bottleneck term from the approximation information. In Embodiment 3, the bottleneck term calculation unit 22 acquires two pieces of information which are generated each time the running subject is run the second time. This is merely an example, and three or more pieces of load information may be acquired. This will be specifically described as follows.

In the bottleneck detection system, there may be a case where performance data 311 of first run of the running subject is largely different from performance data of second run of the running subject. In view of this, in Embodiment 3, a function that causes the bottleneck is extracted by running a total of three times.

(1) In step S301, a performance value recording module 21 generates a first performance graph by first run of the running subject.

(2) In step S302, the performance value recording module 21 generates a second performance graph by second run of the running subject.

(3) The approximation graph generation unit 22a measures an approximation degree AP between the first performance graph and the second performance graph within a range of 0 to 1.0. AP=0 expresses disagreement. AP=1.0 expresses complete agreement. AP has a threshold value at AP=0.7. In step S303, if the approximation degree AP is equal to or more than the threshold value, the approximation graph generation unit 22a generates an approximation graph of the two graphs. The approximation graph is approximation information.

(4) In step S304, the bottleneck term calculation unit 22 calculates a bottleneck term Tb for the approximation graph.

(5) In step S305, a running function recording scheduler 24 generates a trace log during the bottleneck term Tb calculated in step S304, by third run of the running subject.

The operation of the target apparatus 20 in detail will be described with referring to FIG. 13.

In step S31, the performance value recording module 21 generates a first performance graph by first run of the running subject.

In step S32, the bottleneck term calculation unit 22 judges whether or not a bottleneck term Tb exists in the first performance graph. If a bottleneck term Tb exists, the processing proceeds to step S33.

In step S33, the performance value recording module 21 generates a second performance graph by second run of the running subject.

In step S34, the bottleneck term calculation unit 22 judges whether a bottleneck term Tb exists in the second performance graph. If a bottleneck term Tb exists, the processing proceeds to step S35.

In step S35, the approximation graph generation unit 22a finds an approximation degree AP between the first graph and the second graph.

In step S36, the approximation graph generation unit 22a judges whether the approximation degree AP is equal to or more than the threshold value of 0.7. If the approximation degree AP is equal to or more than the threshold value of 0.7, the processing proceeds to step S37.

In step S37, the approximation graph generation unit 22a generates an approximation graph of the first graph and the second graph.

In step S38, the bottleneck term calculation unit 22 calculates the bottleneck term Tb from the approximation graph.

In step S39, by third run of the running subject, the running function recording scheduler 24 records a function to be run in the bottleneck term Tb, using a running function recording module 23.

### ***Effect of Embodiment 3***

According to Embodiment 3, a difference between the first performance graph and the second performance graph is taken into consideration. Therefore, the bottleneck term Tb where a bottleneck is likely to have occurred can be obtained.

### Embodiment 4

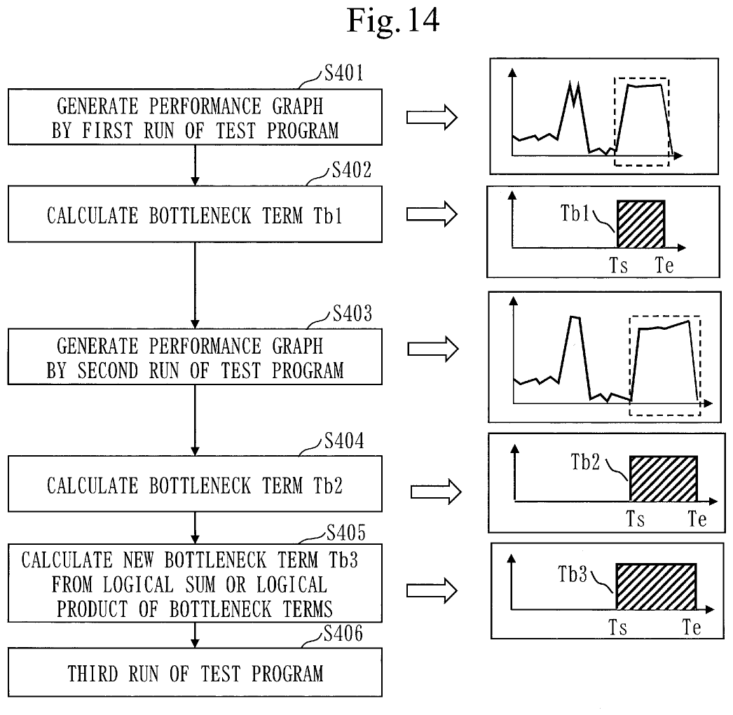

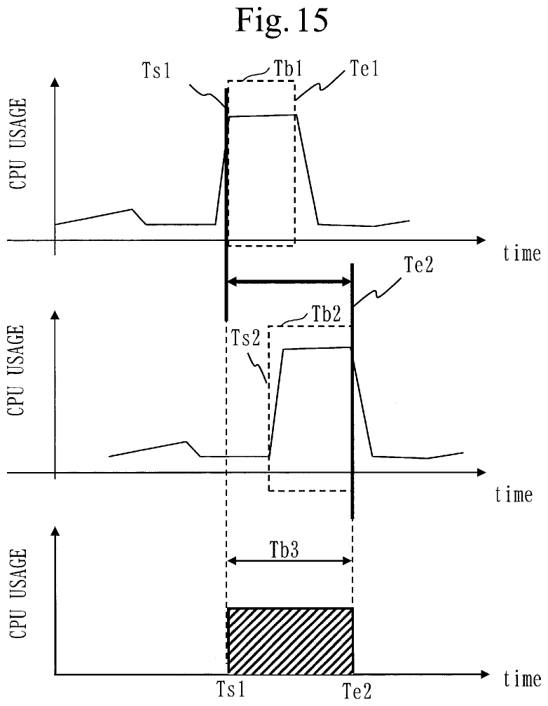

A bottleneck detection system 1004 according to Embodiment 4 will be described with referring to FIGS. 14 and 15. A system configuration of the bottleneck detection system 1004 is the same as that of the bottleneck detection system 1001 and accordingly will not be illustrated.

FIG. 14 is a flowchart illustrating an operation outline of a target apparatus 20 of the bottleneck detection system 1004.

FIG. 15 is a diagram explaining a logical-sum method to be described later. The target apparatus 20 is a bottleneck detection device 100. Operations of the target apparatus 20 will be described with referring to FIG. 14.

In Embodiment 4, a bottleneck term calculation unit 22 acquires a plurality of pieces of load information generated per plurality of times of runs of a running subject which is either one or the other of a single program and a plurality of programs. The plurality of pieces of load information are a plurality of performance graphs. The bottleneck term calculation unit 22 calculates a bottleneck term Tb per plurality of pieces of load information, and generates a new bottleneck term using the plurality of bottleneck terms. A running function recording scheduler 24 records, during run of a running subject which is run after run being an origin of generation of load information, a function which is run during the new bottleneck term Tb, using a running function recording module 23 being a tracing feature.

This is specifically as follows.

(1) In step S401, a performance value recording module 21 generates a first performance graph by first run of the running subject.

(2) In step S402, the bottleneck term calculation unit 22 calculates a first bottleneck term Tb1 from the first performance graph.

(3) In step S403, the performance value recording module 21 generates a second performance graph by second run of the running subject.

(4) In step S404, the bottleneck term calculation unit 22 calculates a second bottleneck term Tb2 from the second performance graph.

(5) In step S405, the bottleneck term calculation unit 22 calculates a new bottleneck term Tb3 from the first bottleneck term Tb1 and the second bottleneck term Tb2. Embodiment 4 is the same as Embodiment 3 in the respect that the bottleneck term Tb is amended.

In Embodiment 4, a start time point Ts of the bottleneck term Tb and an end time point Te of the bottleneck term Tb are amended by calculating a logical sum of the first bottleneck term Tb1 and the second bottleneck term Tb2 (a period from the earliest start time point Ts until the latest end time point Te). In FIG. 15, the bottleneck term Tb3 obtained by calculating the logical sum has a start time point Ts' of the first bottleneck term Tb1 and an end time point Te2 of the second bottleneck term Tb2.

Alternatively, a logical product of the first bottleneck term Tb1 and the second bottleneck term Tb2 (an overlapping term of the first bottleneck term Tb1 and the second bottleneck term Tb2) may be generated as a new bottleneck term Tb3.

(6) In step S406, the running function recording scheduler 24 generates a trace log of the function by third run of the running subject, during the new bottleneck term Tb3 calculated in step S405.

### ***Effect of Embodiment 4***

By calculating a logical sum of bottleneck terms, although a recording size of the trace log increases, a failure of not obtaining a running function by mistake can be prevented.

Also, by calculating a logical product of bottleneck terms, a function that largely influences the bottleneck can be extracted.

(1) Considering a delay that accompanies starting of the running function recording module 23, it may be possible to set, as the start time point Ts, a time point preceding the start time point Ts of the bottleneck term Tb by a predetermined period of time ΔT.

(2) Concerning recording performance data 311 by the performance value recording module 21, recording may be started immediately after the running subject is started.

Alternatively, an external event such as an operation and reception of a communication, or a run start time point of a particular function may be treated as a trigger to start recording.

(3) It is assumed that each unit and each module will be run by a CI tool such as Jenkins. However, this assumption does not necessarily apply if the processing of each flowchart can be automatically executed. For example, if a batch file or a script file is incorporated in the target apparatus 20 in advance and the flow of a flowchart can be executed automatically, a configuration without a CI tool is acceptable.

### Embodiment 5

In Embodiment 5, a hardware configuration of the bottleneck detection device 100 described in Embodiments 1 to 4 will be described. In Embodiment 2, the bottleneck detection device 100 is the host computer 10. In Embodiments 1, 3, and 4, the bottleneck detection device 100 is the target apparatus 20.

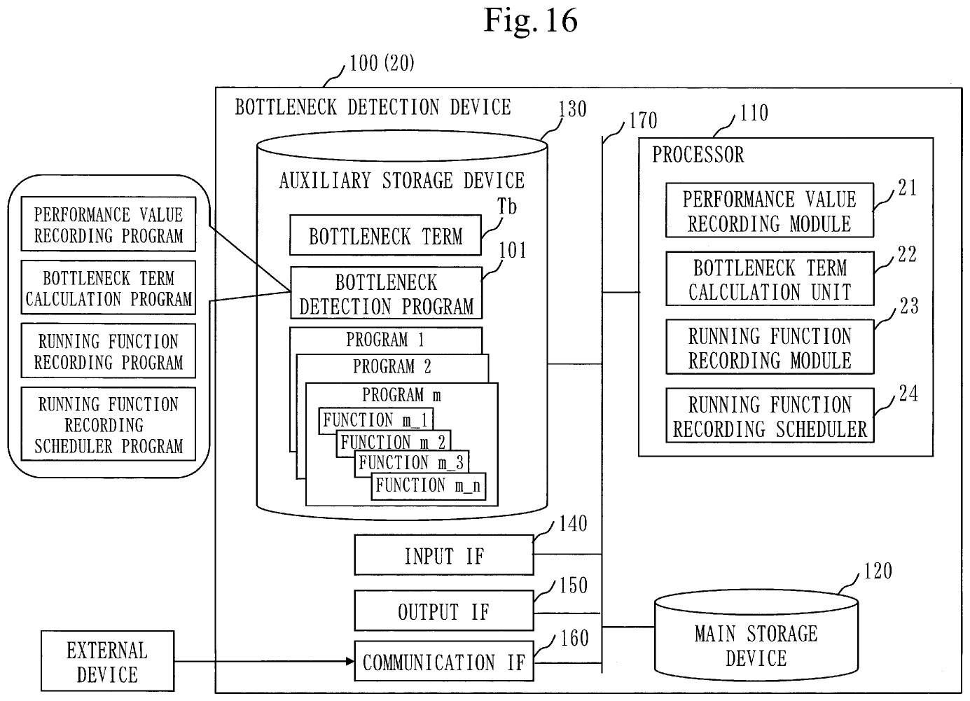

FIG. 16 illustrates a hardware configuration of the target apparatus 20 of FIGS. 1 and 11 which is the bottleneck detection device 100.

In the target apparatus 20 of FIGS. 1 and 11, the performance value recording module 21, the bottleneck term calculation unit 22, the running function recording module 23, and the running function recording scheduler 24 are implemented as the processor 110 of the bottleneck detection device 100 runs the bottleneck detection program 101. In the target apparatus 20 of FIGS. 1 and 11, the first to fifth storage units 31 to 35 correspond to the main storage device 120 or auxiliary storage device 130 of the bottleneck detection device 100,

The bottleneck detection device 100 is a computer. The bottleneck detection device 100 is provided with a processor 110 and also provided with other hardware devices such as a main storage device 120, an auxiliary storage device 130, an input IF 140, an output IF 150, and a communication IF 160. Note that IF stands for interface. The processor 110 is connected to the other hardware devices via a signal line 170 and controls the other hardware devices.

The bottleneck detection device 100 is provided with a performance value recording module 21, a bottleneck term calculation unit 22, a running function recording module 23, and a running function recording scheduler 24, as feature elements. Features of the performance value recording module 21, bottleneck term calculation unit 22, running function recording module 23, and running function recording scheduler 24 are implemented by a bottleneck detection program 101.

As illustrated in FIG. 16, the bottleneck detection program 101 is formed of a performance value recording program, a bottleneck term calculation program, a running function recording program, and a running function recording scheduler program respectively corresponding to the performance value recording module 21, the bottleneck term calculation unit 22, the running function recording module 23, and the running function recording scheduler 24.

The processor 110 is a device that runs the bottleneck detection program 101. The bottleneck detection program 101 is a program that implements the features of the performance value recording module 21, bottleneck term calculation unit 22, running function recording module 23, and running function recording scheduler 24. The processor 110 is an Integrated Circuit (IC) that performs computation processing. Specific examples of the processor 110 include a CPU, a Digital Signal Processor (DSP), and a Graphics Processing Unit (GPU).

Specific examples of the main storage device 120 include a Static Random-Access Memory (SRAM) and a Dynamic Random-Access Memory (DRAM). The main storage device 120 keeps a computation result of the processor 110.

The auxiliary storage device 130 is a storage device that keeps data in a non-volatile manner. The auxiliary storage device 130 stores the bottleneck detection program 101, a bottleneck term Tb, and programs 1, 2, 3, . . . , m. Specific examples of the auxiliary storage device 130 include a Hard Disk Drive (HDD). The auxiliary storage device 130 may be a portable recording medium such as a Secure Digital (SD; registered trademark) memory card, a NAND flash, a flexible disk, an optical disk, a compact disk, a Blu-ray (registered trademark) Disc, and a Digital Versatile Disk (DVD). The auxiliary storage device 130 stores the bottleneck term Tb.

The input IF 140 is a port to which an input device such as a mouse and a keyboard is connected and to which data is inputted from each device.

The output IF 150 is a port to which various types of apparatuses are connected and via which data is outputted to the individual apparatuses by the processor 110.

The communication IF 160 is a communication port via which the processor 110 communicates with another device.

An example of another device is a host computer 10.

The processor 110 loads the bottleneck detection program 101 to the main storage device 120 from the auxiliary storage device 130. The processor 110 reads the bottleneck detection program 101 from the main storage device 120 and runs the bottleneck detection program 101. In addition to the bottleneck detection program 101 and the bottleneck term Tb, an Operating System (OS) is also stored in the main storage device 120. The processor 110 runs the bottleneck detection program 101 while running the OS.

The bottleneck detection device 100 may be provided with a plurality of processors that substitute for the processor 110. The plurality of processors share run of the bottleneck detection program 101. Each processor is a device that runs the bottleneck detection program 101 just as the processor 110 does. Data, information, signal values, and variable values which are utilized, processed, or outputted by the bottleneck detection program 101 are stored in the main storage device 120, the auxiliary storage device 130, or a register or cache memory in the processor 110.

The bottleneck detection program 101 is a program that causes the computer to execute processes, procedures, or stages which are the bottleneck term calculation unit 22 and the running function recording scheduler 24 each with its “unit” being replaced by “process”, “procedure”, or “stage”.

A bottleneck detection method is a method that is conducted as the bottleneck detection device 100 being the computer runs the bottleneck detection program 101. The bottleneck detection program 101 may be provided as being stored in a computer-readable recording medium, or may be provided as a program product.

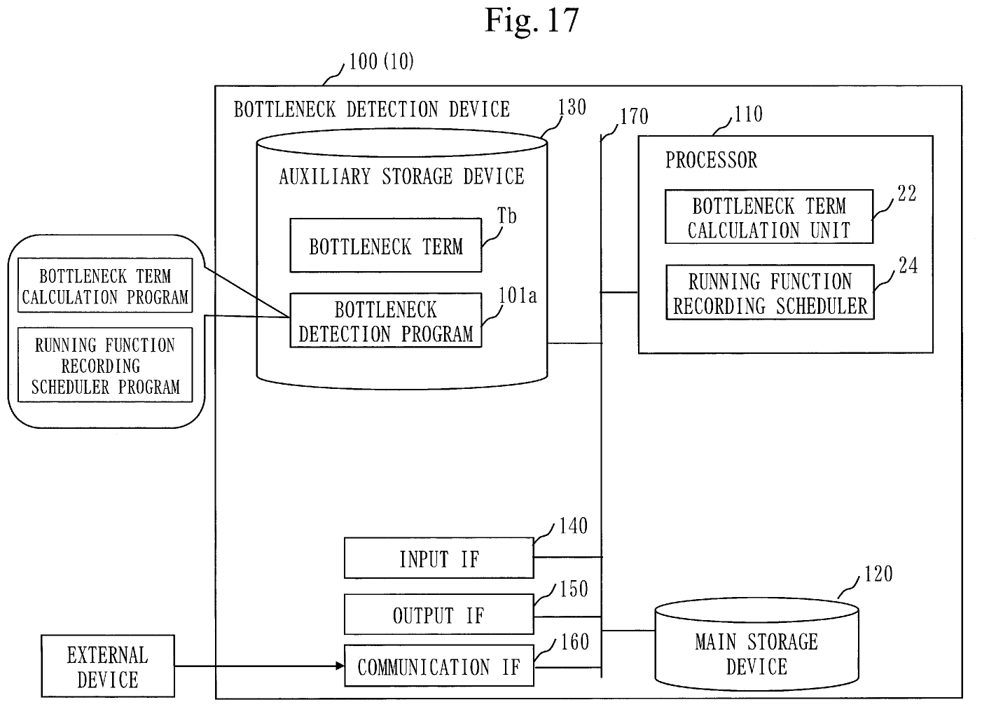

FIG. 17 illustrates a hardware configuration of the host computer 10 of FIG. 10, which is the bottleneck detection device 100.

In the host computer 10 of FIG. 10, the bottleneck term calculation unit 22 and the running function recording scheduler 24 are implemented as the processor 110 of the bottleneck detection device 100 runs a bottleneck detection program 101a.

The bottleneck detection program 101a is formed of a bottleneck term calculation program and a running function recording scheduler program respectively corresponding to the bottleneck term calculation unit 22 and the running function recording scheduler 24.

The bottleneck detection program 101a and a bottleneck term are stored in the auxiliary storage device 130.

<Supplementary to Hardware Configuration>

In the bottleneck detection device 100 of FIGS. 16 and 17, the features of the bottleneck detection device 100 are implemented by software. Alternatively, the features of the bottleneck detection device 100 may be implemented by hardware.

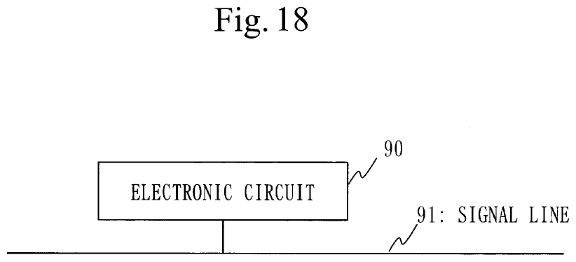

FIG. 18 illustrates a configuration in which the features of the bottleneck detection device 100 are implemented by hardware. An electronic circuit 90 of FIG. 18 is a dedicated electronic circuit that implements the features of the processor 110, main storage device 120, auxiliary storage device 130, input IF 140, output IF 150, and communication IF 160. The electronic circuit 90 is connected to a signal line 91. The electronic circuit 90 is specifically a single circuit, a composite circuit, a programmed processor, a parallel-programmed processor, a logic IC, a GA, an ASIC, or an FPGA. Note that GA stands for Gate Array, ASIC stands for Application Specific Integrated Circuit, and FPGA stands for Field-Programmable Gate Array. The features of the constituent elements of the bottleneck detection device 100 may be implemented by one electronic circuit, or by a plurality of electronic circuits through distribution. The features of some constituent elements of the bottleneck detection device 100 may be implemented by the electronic circuit, and the remaining features may be implemented by software.

The processor 110 and the electronic circuit 90 are each called processing circuitry as well. In the bottleneck detection device 100, features such as the bottleneck term calculation unit 22 and the running function recording scheduler 24 may be implemented by processing circuitry. Alternatively, features such as the bottleneck term calculation unit 22 and the running function recording scheduler 24, and the features of the main storage device 120, auxiliary storage device 130, input IF 140, output IF 150, and communication IF 160 may be implemented by processing circuitry.

Embodiments 1 to 4 have been described above. Of these embodiments, one may be practiced partly. Alternatively, of the plurality of embodiments, two or more may be partly combined and practiced. The present invention is not limited to these embodiments, but may be changed in various manners as necessary.

### REFERENCE SIGNS LIST

Ts: start time point; Te: end time point; Tb: bottleneck term; 10: host computer; 11: program running module; 12: output module; 20: target apparatus; 21:

performance value recording module; 22: bottleneck term calculation unit; 22a: approximation graph generation unit; 23: running function recording module; 24: running function recording scheduler; 31: first storage unit; 32: second storage unit; 33: third storage unit; 34: fourth storage unit; 35: fifth storage unit; 41, 42, 43: range; 90: electronic circuit; 91: signal line; 100: bottleneck detection device; 101: bottleneck detection program; 110: processor; 120: main storage device; 130: auxiliary storage device; 140: input IF; 150: output IF; 160: communication IF; 170: signal line; 311: performance data; 331: running function trace data; 1001, 1002, 1003: bottleneck detection system.

1. A bottleneck detection device comprising:
processing circuitry
to acquire load information which is generated about at least one run of a running subject being either one or the other of a single program and a plurality of programs and which indicates correspondence between a lapse of time and a load quantity being set as a load, and to calculate, using the load information, a bottleneck term indicating a term where the load quantity in a limit status continues; and
to record, during run of the running subject which is run after the run being an origin of generation of the load information, a function which is run during the bottleneck term, using a tracing feature,
wherein the processing circuitry divides the load information into a plurality of, three or more consecutive time zones, and calculates the bottleneck term on a basis of a load average value of a first time zone and a load average value of a second time zone, the first time zone and the second time zone being two time zones on two sides of a central time zone of the three time-consecutive time zones.

2. The bottleneck detection device according to claim 1,
wherein the load information is generated about one run of the running subject, and
wherein the processing circuitry calculates the bottleneck term from the load information.

3. The bottleneck detection device according to claim 2,
wherein the processing circuitry acquires a plurality of pieces of load information generated per plurality of times of runs of the running subject, generates, from the plurality of pieces of load information, approximation information which is approximate to each of the plurality of pieces of load information, and calculates the bottleneck term from the approximation information.

4. The bottleneck detection device according to claim 1,
wherein the processing circuitry
acquires a plurality of pieces of load information generated per plurality of times of runs of the running subject, calculates the bottleneck term per plurality of pieces of load information, and generates a new bottleneck term using the plurality of bottleneck terms, and
records, during run of the running subject which is run after the run being an origin of generation of the load information, a function which is run during the new bottleneck term, using a tracing feature.

5. A non-transitory computer-readable medium recorded with a bottleneck detection program which causes a computer to execute:
a term calculation process of acquiring load information which is generated about at least one run of a running subject being either one or the other of a single program and a plurality of programs and which indicates correspondence between a lapse of time and a load quantity being set as a load, calculating, using the load information, a bottleneck term indicating a term where the load quantity in a limit status continues, dividing the load information into a plurality of, three or more consecutive time zones, and calculating the bottleneck term on a basis of a load average value of a first time zone and a load average value of a second time zone, the first time zone and the second time zone being two time zones on two sides of a central time zone of the three time-consecutive time zones; and
a scheduling process of recording, during run of the running subject which is run after the run being an origin of generation of the load information, a function which is run during the bottleneck term, using a tracing feature.
